(19) United States
(12) Patent Application Publication
(10) Pub. No.: US 2019/0379733 A1
(43) Pub. Date: Dec. 12, 2019

(54) METHOD AND DEVICE FOR MANAGING DATA IN INTERNET OF THINGS, COMPUTER DEVICE AND READABLE MEDIUM

(71) Applicant: BEIJING BAIDU NETCOM SCIENCE AND TECHNOLOGY CO., LTD., Beijing (CN)

(72) Inventors: Miao HUANG, Beijing (CN); Zhi WANG, Beijing (CN); Leding LI, Beijing (CN)

(21) Appl. No.: 16/353,807

(22) Filed: Mar. 14, 2019

(30) Foreign Application Priority Data
Jun. 7, 2018 (CN) 201810582307.5

(51) Int. Cl. H04L 29/08; H04L 12/24; G06F 16/23

(52) U.S. Cl. CPC H04L 67/1065; H04L 67/1063; G06F 16/23; H04L 41/0853; H04L 41/12; H04L 67/12

(57) ABSTRACT

The present disclosure provides a method and device for managing data in Internet of Things, a computer device and a readable medium. The method includes: receiving a relationship data query request carrying a target device identifier sent by a query device; acquiring, based on the target device identifier, all relationship data corresponding to the target device from a relationship database; and returning, to the query device, all the relationship data corresponding to the target device.

### CROSS-REFERENCE TO RELATED APPLICATIONS

This application claims priority to Chinese Patent Application No. 201810582307.5, filed on Jun. 7, 2018, titled “Method and device for managing data in Internet of Things, computer device and readable medium,” which is hereby incorporated by reference in its entirety.

### TECHNICAL FIELD

Embodiments of the present disclosure relate to the field of computer application technology, specifically to a method and device for managing data in Internet of Things, a computer device and a readable medium.

### BACKGROUND

With the development of the Internet of Things technology and the intelligentization of user requirements, more and more devices are connected to the cloud to implement scenarios such as device state monitoring, historical state data storage, cloud control device command, and interaction between cloud control devices.

In the conventional Internet of Things, after a device is accessed to the cloud, data stream generated by the device may be sent to the cloud. The cloud needs to re-organize the matching between the data stream and the device to implement monitoring of the device by the cloud and the linkage between the cloud and the device. In the existing technology, the cloud can only monitor the data of the device, and does not perform any monitoring on the relationship of the device in the physical world. For example, for a building, where are the gateways in the building, which gateways have connections between each other, which air conditioners are included in the building and where are they located, and so on. The cloud does not perform any collecting and managing for the relationship data that identifies the connection relationship, hierarchical relationship or supply relationship of the devices. It requires the manual maintenance by the administrative staff. In the practical application, when the administrative staff maintain certain devices in the Internet of Things, it is usually necessary to acquire the relationship data of these devices to accurately locate the devices. However, according to the existing technology, the relationship data in the Internet of Things can only be memorized and acquired manually, resulting in low query efficiency of the relationship data in the Internet of Things.

### SUMMARY

The present disclosure provides a method and device for managing data in Internet of Things, a computer device and a readable medium, to improve the query efficiency of relationship data in the Internet of Things.

The present disclosure provides a method for managing data in Internet of Things. The method includes: receiving a relationship data query request carrying a target device identifier sent by a query device; acquiring, based on the target device identifier, all relationship data corresponding to the target device from a relationship database; and returning, to the query device, all the relationship data corresponding to the target device.

Further and optionally, in the method as described above, the target device is a physical object, and the other device is a physical object or a virtual object; and/or, the relationship data identifies a connection relationship, a hierarchical relationship, or a supply relationship between the target device and the other device.

Further and optionally, in the method as described above, before acquiring, based on the target device identifier, all relationship data corresponding to the target device from a relationship database, the method further includes: acquiring the relationship data between the target device and the other device in the Internet of Things; and storing the relationship data between the target device and the other device into the relationship database in a tag mode.

Further and optionally, in the method as described above, the tag mode is represented by a key-value.

Further and optionally, in the method as described above, if the target device is a physical object, the method further includes: receiving data uploaded by the target device according to a preset attribute model; and storing the data of the target device into a service database.

Further and optionally, in the method as described above, the preset attribute model includes at least one attribute defined in advance.

Further and optionally, in the method as described above, before storing the data of the target device into a service database, the method further includes: detecting and determining data of a target attribute that needs to be stored according to a pre-configured data storage strategy; and the storing the data of the target device into a service database includes: storing the data of the target attribute of the target device into the service database.

Further and optionally, in the method as described above, the pre-configured data storage strategy includes: storing all the data of the reported target attribute; when the data of the target attribute received this time changes compared with the data stored last time, storing the data this time; or if the data received this time is greater than a preset threshold, storing the data received this time.

The present disclosure provides a cloud server device, the device including: a receiving module configured to receive a relationship data query request carrying a target device identifier sent by a query device; an acquiring module configured to acquire, based on the target device identifier, all relationship data corresponding to the target device from a relationship database; and a sending module configured to return, to the query device, all the relationship data corresponding to the target device.

Further and optionally, in the device as described above, the target device is a physical object, and the other device is a physical object or a virtual object; and/or, the relationship data identifies a connection relationship, a hierarchical relationship, or a supply relationship between the target device and the other device.

Further and optionally, in the device as described above, the device further includes a storing module; the aquiring module is further configured to acquire the relationship data between the target device and the other device in the Internet of Things; and the storing module is configured to store the relationship data between the target device and the other device into the relationship database in a tag mode.

Further and optionally, in the device as described above, the tag mode is represented by a key-value. Further and optionally, in the device as described above, the receiving module is further configured to, if the target device is a physical object, receive data uploaded by the target device according to a preset attribute model; and the storing module is further configured to store the data of the target device into a service database.

Further and optionally, in the device as described above, the preset attribute model includes at least one attribute defined in advance.

Further and optionally, in the device as described above, the device further includes a detection module; the detection module is configured to detect and determine data of a target attribute that needs to be stored according to a pre-configured data storage strategy; and the storing module is configured to store the data of the target attribute of the target device into the service database.

Further and optionally, in the device as described above, the pre-configured data storage strategy includes: storing all the data of the reported target attribute; when the data of the target attribute received this time changes compared with the data stored last time, storing the data this time; or if the data received this time is greater than a preset threshold, storing the data received this time.

The present disclosure further provides a computer device, the device including: one or more processors; and a memory storing one or more programs; wherein the one or more programs, when executed by the one or more processors, cause the one or more processors to implement the method for managing data in the Internet of Things as described above.

The present disclosure further provides a computer readable medium, storing a computer program thereon, wherein the program, when executed by a processor, implements the method for managing data in the Internet of Things as described above.

The method and device for managing data in Internet of Things, a computer device and a readable medium of the present disclosure, receiving a relationship data query request carrying a target device identifier sent by a query device, acquiring, based on the target device identifier, all relationship data corresponding to the target device from a relationship database, and returning, to the query device, all the relationship data corresponding to the target device. The technical solution of the present disclosure may realize the storage of the relationship data of the device by the cloud server in the Internet of Things through the relationship database, thereby supporting the query of the relationship data of the target device. As compared with the prior art relying on artificial memory to query the relationship data in the Internet of Things, the accuracy and efficiency of the query of the relationship data in the Internet of Things can be effectively improved.

### BRIEF DESCRIPTION OF THE DRAWINGS

FIG. 1 is a flowchart of the first embodiment of a method for managing data in the Internet of Things according to the present disclosure.

FIG. 2 is a flowchart of the second embodiment of the method for managing data in the Internet of Things according to the present disclosure.

FIG. 3 is a schematic diagram of a relationship in the Internet of Things provided by an embodiment of the present disclosure.

FIG. 4 is a flowchart of the third embodiment of the method for managing data in the Internet of Things according to the present disclosure.

FIG. 5 is a structural diagram of the first embodiment of a cloud server device according to the present disclosure.

FIG. 6 is a structural diagram of the second embodiment of the cloud server device according to the present disclosure.

FIG. 7 is a structural diagram of an embodiment of a computer device according to the present disclosure.

FIG. 8 is a diagram showing an example of a computer device provided by the present disclosure.

### DETAILED DESCRIPTION OF EMBODIMENTS

In order to make the objectives, technical solution and advantages of the present disclosure more clear, the present disclosure will be described in detail below with reference to the accompanying drawings and specific embodiments.

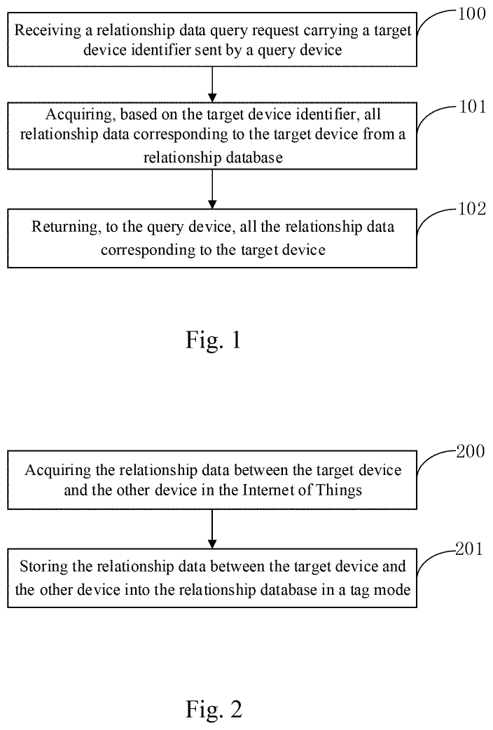

FIG. 1 is a flowchart of the first embodiment of a method for managing data in the Internet of Things according to the present disclosure. As shown in FIG. 1, the method for managing data in the Internet of Things of the present embodiment may specifically include the following steps.

100, receiving a relationship data query request carrying a target device identifier sent by a query device.

101, acquiring, based on the target device identifier, all relationship data corresponding to the target device from a relationship database.

102, returning, to the query device, all the relationship data corresponding to the target device.

The executing body of the method for managing data in the Internet of Things of the present embodiment is a cloud server in the Internet of Things. The cloud server in the physical network of the present embodiment may manage the relationship data in the Internet of Things so that a user may query when needed.

Specifically, when the user queries, a device that can communicate with the cloud server of the Internet of Things may be selected as the query device, and the query device sends a relationship data query request carrying the target device identifier to the cloud server in the physical network. The target device in the present embodiment may be a physical object, such as an air conditioner, a water pump, an automobile, a gateway, or other devices in the Internet of Things. The relationship data query request in the present embodiment may be used to request all relationship data between the target device and other device in the Internet of Things. Other device in the present embodiment may be a physical object or a virtual object in the Internet of Things. The virtual object in the present embodiment represents a virtual space or device in the physical world, such as a room or a floor. That is, all the relationship data between the target device and the other device in the Internet of Things may include not only the relationship data of the target device with other physical objects in the Internet of Things, but also the relationship data of the target device with other virtual devices in the Internet of Things. Optionally, the relationship data in the present embodiment may also be hierarchical relationship data, connection relationship data, or supply relationship data. For example, the X-district includes building No. 1, building No. 2, and building No. 3. The X-district and the building No. 1, building No. 2, and building No. 3 belong to the hierarchical relationship between the including and the being included, and belong to the hierarchical relationship between the virtual objects. The first floor of a building is serviced by air conditioner 1 and air conditioner 2, and the second floor is serviced by air conditioner 3 and air conditioner 4. There is a supply relationship of supplying and being supplied between the air conditioner 1 the first floor of the building, and between the air conditioner 2 and the first floor of the building, and there is also a supply relationship of supplying and being supplied between the air conditioner 3 and the second floor of the building, and between the air conditioner 4 and the second floor of the building. If a gateway is connected to the air conditioner 1 and the air conditioner 3, respectively, for control, then, the gateway has a connection relationship with the air conditioner 1 and the air conditioner 3, respectively.

In the present embodiment, a relationship database may also be pre-stored in the cloud server in the Internet of Things. Relationship data of all devices in the Internet of Things may be stored in the relationship database. In this way, after the cloud server in the Internet of Things receives the relationship data query request carrying the target device identifier sent by the query device, the cloud server may acquire, based on the target device identifier, all the relationship data corresponding to the target device from the relationship database, and return all the relationship data corresponding to the target device to the query device. Further, the management personnel may know all the relationship data of the target device based on all the relationship data corresponding to the target device received by the query device, so as to accurately locate the target device based on all the relationship data of the target device, thereby facilitating the management and maintenance of the target device.

In the method for managing data in the Internet of Things of the present embodiment, receiving a relationship data query request carrying a target device identifier sent by a query device, acquiring, based on the target device identifier, all relationship data corresponding to the target device from a relationship database, and returning, to the query device, all the relationship data corresponding to the target device. The technical solution of the present disclosure may realize the storage of the relationship data of the device by the cloud server in the Internet of Things through the relationship database, thereby supporting the query of the relationship data of the target device. As compared with the prior art relying on artificial memory to query the relationship data in the Internet of Things, the accuracy and efficiency of the query of the relationship data in the Internet of Things can be effectively improved.

FIG. 2 is a flowchart of the second embodiment of the method for managing data in the Internet of Things according to the present disclosure. As shown in FIG. 2, the method for managing data in the Internet of Things of the present embodiment may further include the following steps on the basis of the technical solution of the embodiment shown in FIG. 1.

200, acquiring the relationship data between the target device and the other device in the Internet of Things.

201, storing the relationship data between the target device and the other device into the relationship database in a tag mode.

In the actual scenario, there is a relationship between devices. For example, the gateway is connected to many modbus sub-devices, and the modbus sub-devices transmit data to the cloud server through the gateway. In the same room, there is both an air-conditioning device and two lamp equipments, the temperature adjustment of the air conditioner needs to be referenced by the data of a temperature sensor. In the whole room, there is a relationship between objects. The cloud server also needs to have a description of the relationship between devices in order to build the entire application system. In the present embodiment, based on the idea, the relationship data between the devices is stored in the relationship database of the cloud server.

In the present embodiment, the relationship data between the target device and other device may be manually collected by the collecting personnel. For example, the collecting personnel may collect the relationship between each target device in the current Internet of Things and all other related devices, and report through a collecting terminal to the cloud server of the Internet of Things. The cloud server receives the relationship data between the target device and the other device, and stores the relationship data between the target device and the other device in the relationship database in the tag mode. Optionally, the tag mode in the present embodiment may be represented by a key-value. A tag consists of a key-value. For example, to indicate that the pump is providing energy to building 2, the pump may be given a tag: supplyTo:building 2. If it needs to indicate that building 2 includes the 1^{st} floor and 2^{nd} floor, two tags for building 2 (virtual objects) may be given: contains: floor 1, and contains: floor 2. Therefore, the relationship between the devices and the hierarchical relationship may be described by means of object+tag.

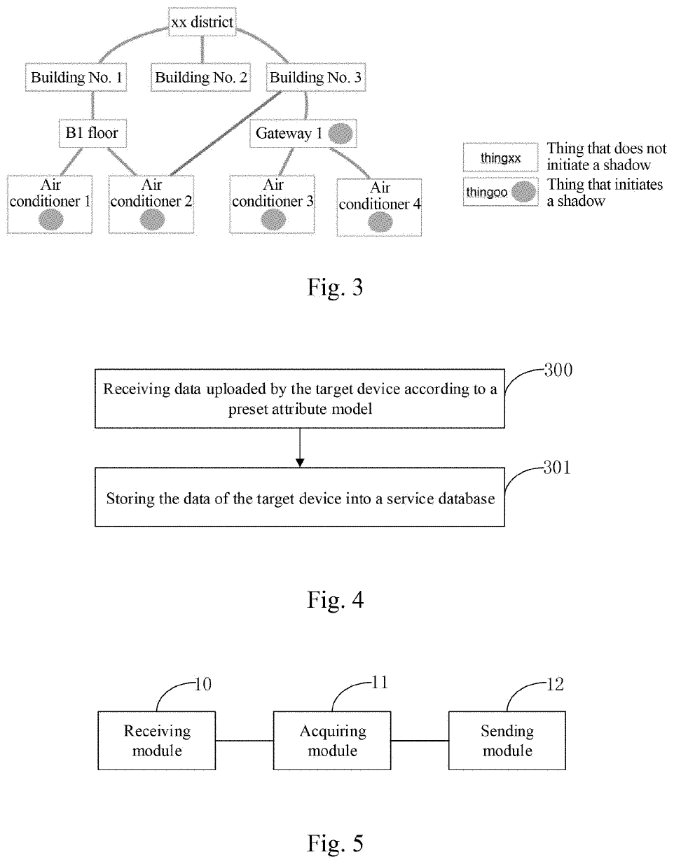

FIG. 3 is a schematic diagram of a relationship in the Internet of Things provided by an embodiment of the present disclosure. The relationship between the devices in the Internet of Things is described based on the above object+tag manner. A relationship diagram as shown in FIG. 3 may be established in the cloud server of the Internet of Things. As shown in FIG. 3, the XX district includes building No. 1, building No. 2, and building No. 3, for example, the building No. 1 has a B1 floor downstairs, and on the B1 floor, an air conditioner 1 and an air conditioner 2 are provided, and the air conditioner 2 is supplied to the building No. 3. At the same time, a gateway 1 is installed in the building No. 3, and the gateway 1 is connected to the air conditioner 3 and an air conditioner 4. Based on the above hierarchical relationship, connection relationship or supply relationship in the physical world, an including and being included relationship may be set between the XX district, and the building No. 1, building No. 2, and building No. 3 respectively, between the building No. 1 and the B1 floor, between the building No. 3 and the gateway, and between the B1 floor, and the air conditioner 1 and the air conditioner 2 respectively through a contains tag. A supplying and being supplied relationship between the air conditioners 2 and the building No. 3 through a supplyTo tag is set. A connecting and being connected relationship between the gateway 1, and the air conditioner 3 and the air conditioner 4 respectively through a subDev tag is set. That is, the relationship description as shown in Table 1 below is obtained. Specifically, in practical application, the different relationships in FIG. 3 may be identified by using different colors or lines with different identifiers. For example, the connection line corresponding to the contains tag may be represented by blue, or may be represented by a solid line; the connection line corresponding to the supplyTo tag may be represented by green, or may be represented by a broken line; the connection line corresponding to the subDev tag may be represented by orange, or may be represented by a dash dot line.

It is also identified in FIG. 3 which devices have physical objects and which devices do not have physical objects. For example, a device having a physical object may be identified as a thing that initiates a shadow, and a device that does not have a physical object may be identified as a thing that does not initiate a shadow. Specifically, the relationship database in the cloud server of the Internet of Things may use the combination of FIG. 3 and Table 1 to store the relationship data between the devices in the Internet of Things.

TABLE 1

| | | Initiate | | | |
|---|---|---|---|---|---|
| Object | Description | shadow | Tag | | |
| diswan | xx district | no | contains: | contains: | contains: |
| | | | building1 | building2 | building3 |
| building1 | building No. | no | contains: | | |
| | 1 | | floorB1 | | |
| building2 | building No. | no | | | |
| | 2 | | | | |
| building3 | building No. | no | contains: | | |
| | 3 | | gateway1 | | |
| floorB1 | B1 floor | no | contains: | contains: | |
| | | | airconditioner1 | airconditioner | |
| | | | | 2 | |
| airconditioner | air | yes | | | |
| 1 | conditioner 1 | | | | |
| gateway 1 | gateway 1 | yes | subDev: | subDev: | |
| | | | airconditioner3 | airconditioner | |
| | | | | 4 | |
| airconditioner | air | yes | supplyTo: | | |
| 2 | conditioner 2 | | building3 | | |
| airconditioner | air | yes | | | |
| 3 | conditioner 3 | | | | |
| airconditioner | air | yes | | | |
| 4 | conditioner 4 | | | | |

The method for managing data in the Internet of Things according to the present embodiment may effectively store the relationship data in the Internet of Things by using the above technical solution, so that the cloud server of the Internet of Things can effectively manage the relationship data in the Internet of Things, thereby supporting the management personnel to query the relationship data in the Internet of Things through a query device, which can effectively improve the accuracy and efficiency of the query of the relationship data in the Internet of Things.

FIG. 4 is a flowchart of the third embodiment of the method for managing data in the Internet of Things according to the present disclosure. As shown in FIG. 4, the method for managing data in the Internet of Things according to the present embodiment may further include the following steps on the basis of the technical solution of the above embodiment, if the target device is a physical object.

300, receiving data uploaded by the target device according to a preset attribute model.

301, storing the data of the target device into a service database.

The cloud server of the Internet of Things in the present embodiment may store data of various attributes of the physical object into the service database in addition to storing to the relationship database.

In the conventional Internet of Things, the cloud server may also monitor and manage the data of an accessed device. Specifically, the cloud server does not have a unified model management, and the user of the device itself programs and organizes the data stream of the device according to its own format and sends the data stream to the cloud server. The cloud server needs to re-organize the matching between the data stream and the device, to realize the monitoring of the device by the cloud and linkage between the cloud and the device. In this way, in order to clearly indicate the value of each attribute, when the device uploads the attribute data to the cloud server, the device not only needs to upload the data, but also uploads the attribute information corresponding to the data, that is, for each attribute information, the format of the uploaded data is the attribute information field+value. In the above existing technical solution, in the data uploaded by the device, the really valid numerical part occupies a small amount of resources, and the attribute information occupies more resources, resulting in waste of resources.

In order to solve the problem, in the present embodiment, considering that a type of device has a common attribute, in a device monitoring scenario, multiple attributes of the device need to be monitored, and each device needs to monitor which attributes are not changed in a period of time. Therefore, an attribute model may be established for the device, and the attribute model may include at least one attribute defined in advance.

For example, for a water pump, its attribute model may be established including input frequency, output frequency, electric current, torque, output power, DC voltage, output voltage, frequency converter temperature, and the like. For any device, if the user wants to store its service data in the cloud server, a corresponding attribute model may be established based on the attributes of the device. The device and the cloud server may upload data according to the attribute model without uploading the attribute information corresponding to each data. For example, for the above water pump, according to the prior art, for each attribute such as the input frequency, output frequency, electric current, torque, output power, DC voltage, output voltage, and frequency converter temperature, the attribute information field+data needs to be uploaded. While by using the attribute model of the present embodiment, a group of data corresponding to the water pump may be directly uploaded, and the pump identifier+the group data may be uploaded.

Correspondingly, after receiving the water pump identifier and the group data, the cloud server defaults the group of data to be the data of the attributes of the water pump corresponding to the water pump identifier. Specifically, the first data in the group of data corresponds to the input frequency value, the second data corresponds to the output frequency value, the third data corresponds to the electric current value, the fourth data corresponds to the torque value, the fifth data corresponds to the output power value, the sixth data corresponds to the DC voltage value, the seventh data corresponds to the output voltage value, the eighth data corresponds to the frequency converter temperature value, and so on. In this way, the cloud server has a cloud backup of a real device. In addition, due to some requirements for the data in the Internet of Things (IoT) scenario, the definition to the attribute in the attribute model may also be multi-dimensional, for example, an attribute may include multiple dimensions such as attribute name, display name, data type, default value, update time, unit, and the like. In this way, when the device sends the corresponding attribute value to the cloud server according to the attribute model, the cloud server may reflect the current state of the device in real time. In the present embodiment, a corresponding application program may also be provided, and the cloud server may be directly accessed to perform various operations, such as storing data, displaying on the user's mobile phone APP and monitoring large screen. In addition, the type of the attribute in the attribute model may also be used to automatically convert and correct the data format uploaded by the device.

Furthermore, the attribute model of the present embodiment may have an inherited relationship. For example, an attribute model of a vehicle may include: a window controller state, an engine temperature, a water temperature, a brake state, and the like. The attribute model of a passenger car may be inherited from the attribute model of the vehicle, including not only all the attributes of the vehicle, but also the unique attributes of the passenger car, such as the seating capacity. A new energy automobile may also inherit the attribute model of the passenger car, including all the attributes of the passenger car, as well as the unique attributes of the new energy automobile, such as the remaining power and the state of charge. A BYD electric automobile may reference the attribute model of this new energy automobile. Each new energy automobile may reference this attribute model. These new energy automobiles have a unified representation in the cloud server, and the application may communicate between the devices by referring to different devices.

Further and alternatively, the step 301 “storing the data of the attribute of the target device into a service database” may specifically include the following steps.

(a) detecting whether the data of the target attribute needs to be stored according to a pre-configured data storage strategy; if the storage is required, step (b) is performed; otherwise, the data is discarded.

(b) storing the data of the target attribute of the target device.

For example, in the present embodiment, the data storage strategy pre-configured in the cloud server of the Internet of Things may specifically include the following three conditions.

The first condition: storing all the data of the reported target attribute.

In this case, after the target device uploads the data according to the preset attribute model, the cloud server determines, based on the data storage strategy, that each attribute is the target attribute, and the data of each attribute needs to be stored. At this time, the cloud server stores the data of all the attributes reported by the target device.

The second condition: when the data of the target attribute received this time changes compared with the data stored last time, storing the data this time.

In this case, if the cloud server receives the data of the target attribute uploaded by the target device for the first time, since the historical data of the target attribute of the target device is empty, the cloud server directly stores the data of the target attribute of the target device. After receiving the data of the target attribute reported by the target device in the second time and subsequent times, the cloud server may store the current data when the data of the target attribute received this time changes compared with the the data stored last time based on the data stored according to the preset attribute model and the pre-configured data storage strategy.

The third condition: if the data received this time is greater than a preset threshold, storing the data received this time.

In this case, a preset threshold may be set based on experience. Specifically, for each attribute, a corresponding preset threshold may be set respectively. If the value of the attribute in the data received this time is greater than the preset threshold, the data received this time is stored.

In an IoT scenario, the user may also use an application in the device to access the cloud server. The user accessing to the cloud server may have multiple scenarios: for example, the device needs to update the corresponding shadow data stored by the cloud server, the user's application needs permission to access one or more devices, or a gateway has permission to update the sub-devices under it. This requires the cloud server to have a permission management configuration for the device. The user may create a permission, associate the permission with one or more devices, and have corresponding addition, deletion, modification, and querying operations. The device may use the username and password of this permission to connect and access to the cloud server.

The method for managing data in the Internet of Things of the present embodiment may upload the attribute data to the cloud server using a preset attribute model by using the above technical solution, and only upload valid data of the attribute during the uploading process, which effectively saves the bandwidth resources of the device to upload data to the cloud server, and improves the data upload efficiency. In addition, in the technical solution of the present embodiment, the cloud server may flexibly store the data of the device according to the pre-configured data storage strategy, thereby improving the data management efficiency.

FIG. 5 is a structural diagram of the first embodiment of a cloud server device according to the present disclosure. As shown in FIG. 5, the cloud server device of the present embodiment may specifically include: a receiving module 10, configured to receive a relationship data query request carrying a target device identifier sent by a query device; an acquiring module 11, configured to acquire, based on the target device identifier received by the receiving module 10, all relationship data corresponding to the target device from a relationship database; and a sending module 12, configured to return, to the query device, all the relationship data corresponding to the target device acquired by the acquiring module 11.

The cloud server device of the present embodiment implements the data management in the Internet of Things by using the above modules, and the implementation principle and the technical effects thereof are the same as the implementation of the related method embodiments. For details, refer to the description of the foregoing related method embodiments, and repeated description thereof will be omitted.

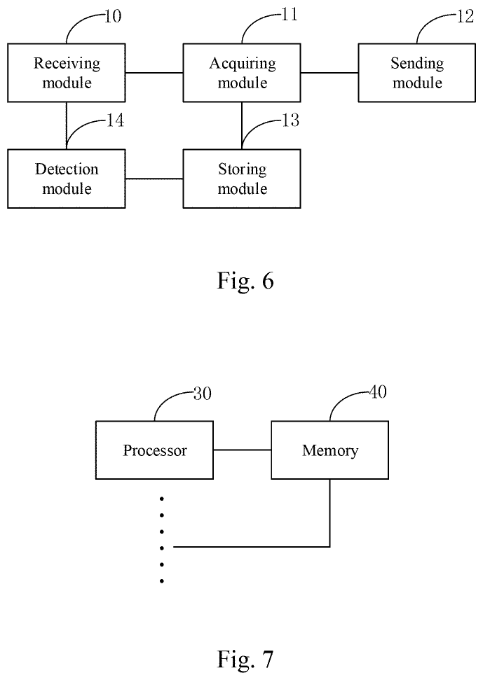

FIG. 6 is a structural diagram of the second embodiment of the cloud server device according to the present disclosure. As shown in FIG. 6, the cloud server device of the present embodiment further describes the technical solution of the present disclosure in further details on the basis of the technical solution of the embodiment shown in FIG. 5.

In the cloud server device of the present embodiment, the target device is a physical object, and the other device is a physical object or a virtual object; and/or the relationship data identifies a connection relationship, a hierarchical relationship, or a supply relationship between the target device and the other device.

Further and optionally, as shown in FIG. 6, in the cloud server device of the present embodiment, a storing module 13 is further included.

The acquiring module 11, is further configured to acquire the relationship data between the target device and the other device in the Internet of Things.

The storing module 13, is configured to store the relationship data between the target device and the other device, acquired by the acquiring module 11, into the relationship database in a tag mode.

Further and optionally, the tag mode is represented by a key-value.

Further and optionally, in the cloud server device of the present embodiment, the receiving module 10 is further configured to, if the target device is a physical object, receive data uploaded by the target device according to a preset attribute model; and the storing module 13, is further configured to store the data of the target device received by the receiving module 10 into a service database.

Further and optionally, the preset attribute model includes at least one attribute defined in advance.

Further and optionally, as shown in FIG. 6, in the cloud server device of the present embodiment, the device further includes a detection module 14.

The detection module 14, is configured to detect and determine data of a target attribute that needs to be stored among the data received by the receiving module 10 according to a pre-configured data storage strategy; and the storing module 13, is specifically configured to store the data of the target attribute of the target device that is determined by the detection module 14 into the service database.

Further and optionally, the pre-configured data storage strategy includes: storing all the data of the reported target attribute; when the data of the target attribute received this time changes compared with the data stored last time, storing the data this time; or if the data received this time is greater than a preset threshold, storing the data received this time.

The cloud server device of the present embodiment implements the data management in the Internet of Things by using the above modules, and the implementation principle and the technical effects thereof are the same as the implementation of the related method embodiments. For details, refer to the description of the foregoing related method embodiments, and repeated description thereof will be omitted.

FIG. 7 is a structural diagram of an embodiment of a computer device of the present disclosure. As shown in FIG. 7, the computer device of the present embodiment includes: one or more processors 30, and a memory 40 for storing one or more programs, where the one or more programs stored in the memory 40, when being executed by the one or more processors 30, cause the one or more processes 30 to implement the method for managing data in the Internet of Things as in the embodiments shown in FIG. 1 to FIG. 4. In the embodiment shown in FIG. 7, a plurality of processors 30 are included as an example. The computer device of the present embodiment may be used as the cloud server device in the Internet of Things.

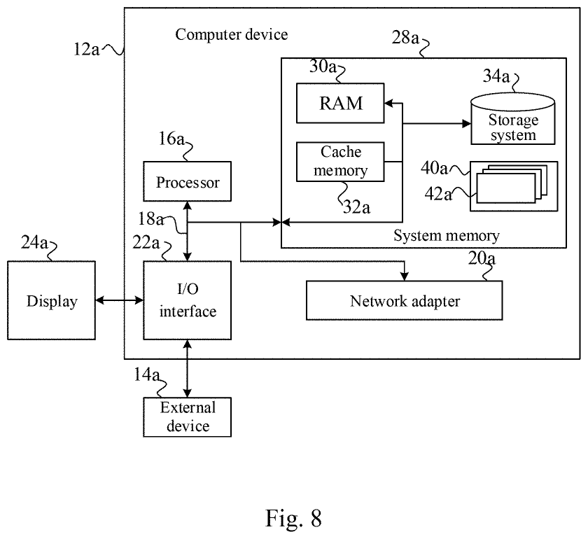

For example, FIG. 8 is a diagram showing an example of a computer device provided by the present disclosure. FIG. 8 shows a block diagram of an exemplary computer device 12a adapted to implement embodiments of the present disclosure. The computer device 12a as shown in FIG. 8 is merely an example and should not impose any limitation on the function and scope of use of the embodiments of the present disclosure.

As shown in FIG. 8, the computer device 12a is embodied in the form of a general-purpose computing device. The components of the computer device 12a may include, but are not limited to, one or more processors 16a, a system memory 28a, and a bus 18a that connects different system components, including the system memory 28a and the processor 16a.

The bus 18a represents one or more of several types of bus structures, including a memory bus or memory controller, a peripheral bus, a graphics acceleration port, a processor, or a local bus using any of a variety of bus structures. For example, these architectures include, but not limited to, Industry Standard Architecture (ISA) bus, Micro Channel Architecture (MAC) bus, Enhanced ISA bus, Video Electronics Standards Association (VESA) local bus, and Peripheral Component Interconnects (PCI) bus.

The computer device 12a typically includes a variety of computer system readable mediums. These mediums may be any available medium that can be accessed by the computer device 12a, including transitory and non-transitory medium, removable and non-removable medium.

The system memory 28a may include computer system readable medium in the form of transitory memory, such as a random access memory (RAM) 30a and/or a cache memory 32a. The computer device 12a may further include other removable/non-removable, transitory/non-transitory computer system storage mediums. For example, a storage system 34a may be used to read and write non-removable, non-transitory magnetic medium (not shown in FIG. 8, commonly referred to as “hard disk drive”). Although not shown in FIG. 8, a disk drive for reading and writing a removable non-transitory disk (such as a “floppy disk”), and an optical disc drive for reading and writing a removable non-transitory disc (such as a CD-ROM, DVD-ROM or other optical mediums) may be provided. In these cases, each drive may be coupled to the bus 18a via one or more data medium interfaces. The system memory 28a may include at least one program product having a set (e.g., at least one) of program modules configured to perform the functions of the various embodiments of the present disclosure in the above FIG. 1 to FIG. 6.

A program/utility tool 40a having a set (at least one) of program modules 42a may be stored, for example, in the system memory 28a, such program modules 42a including, but not limited to, an operating system, one or more applications, other program modules and program data, and each of these examples or some combination may include the implementation of a network environment. The program module 42a typically performs the functions and/or method in the described various embodiments of the present disclosure in the above FIG. 1 to FIG. 6.

The computer device 12a may also be in communication with one or more external devices 14a (e.g., a keyboard, pointing device, display 24a, etc.), and may also be in communication with one or more devices that enable the user to interact with the computer device 12a, and/or in communication with any device (e.g., a network card, a modem, etc.) that enables the computer device 12a to communicate with one or more other computing devices. This communication may take place via an input/output (I/O) interface 22a. Also, the computer device 12a may also communicate with one or more networks (e.g., a local area network (LAN), a wide area network (WAN), and/or a public network, such as the Internet) through a network adapter 20a. As shown in the figures, the network adapter 20a communicates with other modules of the computer device 12a via the bus 18a. It should be understood that although not shown in the figures, other hardware and/or software modules may be utilized in conjunction with the computer device 12a, including but not limited to: microcode, device drivers, redundant processors, external disk drive arrays, RAID systems, tape drives and data backup storage systems.

The processor 16a executes various functional applications and data processing by running programs stored in the system memory 28a, such as implementing the method for managing data in Internet of Things as shown in the above embodiments.

The present disclosure also provides a computer readable medium, storing a computer program thereon, where the program, when executed by a processor, implements the method for managing data in Internet of Things as shown in the above embodiments.

The computer readable medium of the present embodiment may include the RAM 30a, and/or the cache memory 32a, and/or the storage system 34a in the system memory 28a in the above embodiment as shown in FIG. 8.

With the development of science and technology, the propagation of computer programs is no longer limited by tangible mediums, and may also be downloaded directly from the network or obtained in other ways. Therefore, the computer readable medium in the present embodiment may include not only the tangible mediums but also intangible mediums.

The computer readable medium of the present embodiment may employ any combination of one or more computer readable mediums. The computer readable medium may be a computer readable signal medium or a computer readable storage medium. The computer readable storage medium may be, for example, but not limited to, an electronic, magnetic, optical, electromagnetic, infrared, or semiconductor system, apparatus, or device, or any combination of the above. More specific examples (a non-exhaustive list) of the computer readable storage medium include: an electrical connection with one or more wires, portable computer disk, hard disk, random access memory (RAM), read only memory (ROM), erasable programmable read only memory (EPROM or flash), optical fiber, portable compact disk read only memory (CD-ROM), optical storage device, magnetic storage device, or any suitable combination of the above. In this disclosure, the computer readable storage medium may be any tangible medium that contains or stores a program, and the program may be used by or used in connection with a command execution system, apparatus, or device.

The computer readable signal medium may include data signal in the base band or propagating as parts of a carrier, in which computer readable program codes are carried. The propagating data signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element.

The program codes contained on the computer readable medium may be transmitted with any suitable medium including but not limited to: wireless, wired, optical cable, RF medium etc., or any suitable combination of the above.

A computer program code for performing operations in the present disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on the user's computer, partially executed on the user's computer, executed as a separate software package, partially executed on the user's computer and partially executed on a remote computer, or completely executed on a remote computer or server. In the circumstance involving a remote computer, the remote computer may be connected to the user's computer through any network, including local area network (LAN) or wide area network (WAN), or may be connected to an external computer (for example, connected through the Internet using an Internet service provider).

In the several embodiments provided by the present disclosure, it should be understood that the disclosed system, apparatus and method may be implemented in other manners. For example, the apparatus embodiment described above is merely illustrative. For example, the division of the units is only a logical function division, and in the actual implementation, another division method may be possible.

The units described as separate components may or may not be physically separated, and the components displayed as units may or may not be physical units, that is, may be located in one place, or may be distributed to multiple network units. Some or all of the units may be selected according to actual needs to achieve the purpose of the solution of the present embodiment.

In addition, the functional units in the embodiments of the present disclosure may be integrated into one processing unit, or may exist physically separately, or two or more units may be integrated into one unit. The above integrated unit may be implemented in the form of hardware or in the form of hardware plus software functional units.

The above integrated unit implemented in the form of a software functional unit may be stored in a computer readable storage medium. The software functional unit is stored in a storage medium and includes instructions for causing a computer device (which may be a personal computer, a server, or a network device, etc.) or a processor to perform part of the steps of the method of the various embodiments of the present disclosure. The foregoing storage medium includes: a U disk, a mobile hard disk, a read-only memory (ROM), a random access memory (RAM), a magnetic disk, or an optical disk, and various mediums that can store program codes.

The above is only the preferred embodiments of the present disclosure, and is not intended to limit the present disclosure. Any modifications, equivalent substitutions, improvements, etc. within the spirit and principles of the present disclosure, should be included in the scope of protection of the present disclosure.

What is claimed is:

1. A method for managing data in an Internet of Things, the method comprising:
receiving a relationship data query request carrying a target device identifier sent by a query device;
acquiring, based on the target device identifier, all relationship data corresponding to the target device from a relationship database; and
returning, to the query device, all the relationship data corresponding to the target device.

2. The method according to claim 1, wherein the relationship data identifies a connection relationship, a hierarchical relationship, or a supply relationship between the target device and another device.

3. The method according to claim 2, wherein the target device is a physical object, and the other device is a physical object or a virtual object.

4. The method according to claim 1, wherein before acquiring, based on the target device identifier, all relationship data corresponding to the target device from a relationship database, the method further comprises:
acquiring the relationship data between the target device and another device in the Internet of Things; and
storing the relationship data between the target device and the other device into the relationship database in a tag mode.

5. The method according to claim 4, wherein the tag mode is represented by a key-value.

6. The method according to claim 1, wherein, if the target device is a physical object, the method further comprises:
receiving data uploaded by the target device according to a preset attribute model; and
storing the data of the target device into a service database.

7. The method according to claim 6, wherein the preset attribute model comprises at least one attribute defined in advance.

8. The method according to claim 6, wherein before storing the data of the target device into a service database, the method further comprises:
detecting and determining data of a target attribute that needs to be stored according to a pre-configured data storage strategy; and
the storing the data of the target device into a service database comprises: storing the data of the target attribute of the target device into the service database.

9. The method according to claim 8, wherein the pre-configured data storage strategy comprises: storing all the data of the reported target attribute; when the data of the target attribute received this time changes compared with the data stored last time, storing the data this time; or if the data received this time is greater than a preset threshold, storing the data received this time.

10. A cloud server device, the device comprising:
at least one processor; and
a memory storing instructions, wherein the instructions when executed by the at least one processor, cause the at least one processor to perform operations, the operations comprising:
receiving a relationship data query request carrying a target device identifier sent by a query device;
acquiring, based on the target device identifier, all relationship data corresponding to the target device from a relationship database; and
returning, to the query device, all the relationship data corresponding to the target device.

11. The device according to claim 10, wherein the relationship data identifies a connection relationship, a hierarchical relationship, or a supply relationship between the target device and another device.

12. The device according to claim 11, wherein the target device is a physical object, and the other device is a physical object or a virtual object.

13. The device according to claim 10, wherein before acquiring, based on the target device identifier, all relationship data corresponding to the target device from a relationship database, the operations further comprise:
acquiring the relationship data between the target device and another device in the Internet of Things; and
storing the relationship data between the target device and the other device into the relationship database in a tag mode.

14. The device according to claim 13, wherein the tag mode is represented by a key-value.

15. The device according to claim 13, wherein:
if the target device is a physical object, the operations further comprise:
receiving data uploaded by the target device according to a preset attribute model; and
storing the data of the target device into a service database.

16. The device according to claim 15, wherein the preset attribute model comprises at least one attribute defined in advance.

17. The device according to claim 15, wherein before storing the data of the target device into a service database, the operations further comprise:
detecting and determining data of a target attribute that needs to be stored according to a pre-configured data storage strategy; and
the storing the data of the target device into a service database comprises: storing the data of the target attribute of the target device into the service database.

18. The device according to claim 16, wherein the pre-configured data storage strategy comprises: storing all the data of the reported target attribute; when the data of the target attribute received this time changes compared with the data stored last time, storing the data this time; or if the data received this time is greater than a preset threshold, storing the data received this time.

19. A non-transitory computer readable medium, storing a computer program thereon, wherein the computer program, when executed by a processor, causes the processor to perform operations, the operations comprising:
receiving a relationship data query request carrying a target device identifier sent by a query device;
acquiring, based on the target device identifier, all relationship data corresponding to the target device from a relationship database; and
returning, to the query device, all the relationship data corresponding to the target device.
